(19) United States
(12) Patent Application Publication
(10) Pub. No.: US 2013/0100375 A1
(43) Pub. Date: Apr. 25, 2013

(54) DISPLAY DEVICE, SPACER, AND ELECTRONIC APPARATUS

(71) Applicant: SONY CORPORATION, Tokyo (JP)

(72) Inventor: Yuichi Inoue, Kanagawa (JP)

(73) Assignee: SONY CORPORATION, Tokyo (JP)

(21) Appl. No.: 13/649,508

(22) Filed: Oct. 11, 2012

(30) Foreign Application Priority Data
Oct. 21, 2011 (JP) 2011-232101

(51) Int. Cl. G02F 1/13357; G02F 1/1339

(52) U.S. Cl. 349/61; 349/96; 349/155

(57) ABSTRACT

A spacer is disposed between two polarizing plates. The spacer has a retardation value of 40 [nm] or less.

### BACKGROUND

The present disclosure relates to a display device including liquid crystal elements, a spacer employed in the display device, and an electronic apparatus including the display device.

A display device realizing stereoscopic vision display has recently attracted more attention. The stereoscopic vision display is to display a left-eye image and a right-eye image that have parallax with respect to one another (different perspectives), and a viewer sees the respective images with his or her right and left eyes, so as to perceive a stereoscopic image having depth. There has also been developed a display device that displays three or more images that have parallax with respect to one another, thereby providing a more natural stereoscopic image for a viewer.

The above-mentioned display devices are roughly categorized into those using special glasses and those using no special glasses. A viewer often feels it inconvenient to use such special glasses, thus there has been desired a display device using no special glasses. Examples of a display device using no special glasses include a parallax barrier system and a lenticular lens system, for example. These systems display a plurality of images that have parallax with respect to one another (perspective images) at a time such that viewed images appear differently due to a relative positional relation (viewing angle) between a display device and a perspective of a viewer. For example, Japanese Unexamined Patent Application Publication No. H03-119889 discloses a display device employing the parallax barrier system using liquid crystal elements as barriers.

In a display device using the parallax barrier system, a predetermined distance is generally provided between a display panel and a barrier such that viewed images appear different based on the viewing angle. For this purpose, a spacer may be inserted to maintain the predetermined distance. Japanese Unexamined Patent Application Publication No. 2004-294484 discloses a display device using for a spacer glass having a larger thermal expansion coefficient than that of a glass substrate included in a liquid crystal display panel. This display device focuses on that the display panel is disposed closer to a backlight than the spacer member, and uses the above-mentioned glass as a spacer so as to reduce a difference in thermal expansion between the liquid crystal display panel and the spacer, thereby reducing deterioration of image quality resulting from distortion at the joint portion between the panel and spacer.

### SUMMARY

Use of a spacer capable of suppressing deterioration of image quality has been desired as described above in the case where insertion of a spacer member between a display panel and a barrier is necessary.

It is desirable to provide a display device, a spacer, and an electronic apparatus capable of suppressing deterioration of image quality.

A display device according to an embodiment of the present disclosure includes: a liquid crystal display section displaying an image; a barrier section including liquid crystal barriers allowed to switch between open state and closed state; and a spacer disposed between the liquid crystal display section and the barrier section, and having a retardation value of 40 [nm] or less.

A spacer according to an embodiment of the present disclosure is disposed between two polarizing plates. The spacer has a retardation value of 40 [nm] or less.

An electronic apparatus according to an embodiment of the present disclosure has a display device, and a controller that performs operation control using the display device. The display device includes: a liquid crystal display section displaying an image; a barrier section including liquid crystal barriers allowed to switch between open state and closed state; and a spacer disposed between the liquid crystal display section and the barrier section, and having a retardation value of 40 [nm] or less.

Examples of the electronic apparatus include, for example but not limited to, a television apparatus, a digital camera, a personal computer, a video camera, and a mobile terminal including a mobile phone.

In the display device, the spacer, and the electronic apparatus according to the above-described respective embodiments of the present disclosure, the liquid crystal barriers are set to be in the transmission state to allow a viewer to visually perceive the image displayed on the liquid crystal display section. At this time, light transmits through the spacer that is disposed between the liquid crystal display section and the barrier section and that has the retardation value of 40 [nm] or less.

According to the display device, the spacer, and the electronic apparatus of the above-described respective embodiments of the present disclosure, the spacer disposed between the liquid crystal display section and the barrier section is configured to have the retardation value of 40 [nm] or less. Therefore, it is possible to suppress deterioration of image quality.

### BRIEF DESCRIPTION OF THE DRAWINGS

FIG. 1 is a block diagram illustrating one configuration example of a stereoscopic display device according to an embodiment of the present disclosure.

FIGS. 2A and 2B are explanation diagrams each illustrating one configuration example of the stereoscopic display device of FIG. 1.

FIG. 3 is a block diagram illustrating one configuration example of a display drive section of FIG. 1.

FIGS. 4A and 4B are explanation diagrams each illustrating one configuration example of a display section of FIG. 1.

FIGS. 5A and 5B are explanation diagrams each illustrating a barrier section of FIG. 1.

FIG. 6 is an explanation diagram illustrating an example of a group configuration of the barrier section of FIG. 1.

FIGS. 7A to 7D are schematic diagrams each illustrating one operational example of the display section and the barrier section of FIG. 1.

FIG. 8 is an explanation diagram illustrating one example of an outline configuration of the stereoscopic display device of FIG. 1.

FIG. 9 is a schematic diagram illustrating one operational example of stereoscopic vision display of the stereoscopic display device of FIG. 1.

FIG. 10 is a schematic diagram illustrating distribution of stress in the spacer of FIG. 8.

FIG. 11 is a schematic diagram illustrating distribution of a direction of a slow axis in the spacer of FIG. 8.

FIG. 12 is a schematic diagram illustrating transmittance characteristics of the barrier section of FIG. 1.

FIG. 13 is a characteristic diagram illustrating one example of crosstalk characteristics during the stereoscopic vision display.

FIG. 14 is a characteristic diagram illustrating a relation between the crosstalk and the contrast.

FIG. 15 is an explanation diagram illustrating one example of an outline configuration of the stereoscopic display device according to a modification of the present embodiment.

FIG. 16 is a perspective view illustrating an appearance configuration of a television apparatus to which the stereoscopic display device according to one embodiment is applied.

FIGS. 17A and 17B are explanation diagrams each illustrating one configuration example of the stereoscopic display device according to a modification.

FIG. 18 is an explanation diagram illustrating one example of a configuration outline of the stereoscopic display device of FIGS. 17A and 17B.

FIG. 19 is a schematic diagram illustrating one operational example of the stereoscopic vision display in the stereoscopic display device of FIGS. 17A and 17B.

FIG. 20 is an explanation diagram illustrating one example of an outline configuration of the stereoscopic display device according to another modification.

### DETAILED DESCRIPTION

Hereinafter, detailed description will be provided on an embodiment of the present disclosure with reference to the drawings. The description will be made in the following order.

### 1. Embodiment

### 2. Application Examples

### 1. EMBODIMENT

### Configuration Example

### (Outline of Configuration Example)

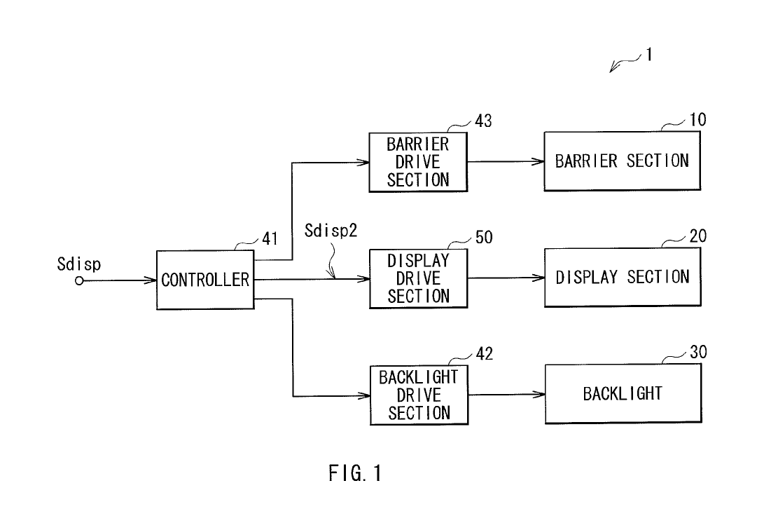

FIG. 1 illustrates one configuration example of a stereoscopic display device according to the present embodiment. The stereoscopic display device 1 is a display device using the parallax barrier system including liquid crystal barriers. It should be noted that a spacer according to an embodiment of this disclosure is embodied by the present embodiment, thus description thereof will also be provided collectively. The stereoscopic display device 1 includes a controller 41, a backlight drive section 42, a backlight 30, a display drive section 50, a display section 20, a barrier drive section 43, and a barrier section 10.

The controller 41 is (or includes) a circuit providing a control signal for the backlight drive section 42, the display drive section 50, and the barrier drive section 43, respectively, based on an image signal Sdisp provided from outside, and controls these sections to operate synchronously with one another. Specifically, the controller 41 provides a backlight control signal for the backlight drive section 42, provides an image signal Sdisp2 generated based on the image signal Sdisp for the display drive section 50, and provides a barrier control signal for the barrier drive section 43. The image signal Sdisp2 is an image signal S2D including a single perspective image if the stereoscopic display device 1 performs normal display (2D display), and is an image signal S3D including a plurality of (eight in this example) perspective images if the stereoscopic display device 1 performs stereoscopic vision display, as described later.

The backlight drive section 42 drives the backlight 30 based on the backlight control signal provided from the controller 41. The backlight 30 has a function for radiating surface-emitted light relative to the display section 20. The backlight 30 includes LED (light-emitting diode) or CCFL (cold cathode fluorescent lamp), for example.

The display drive section 50 drives the display section 20 based on the image signal Sdisp2 provided from the controller 41. The display section 20 is a liquid crystal section in this example, and drives liquid crystal display elements and modulates light radiated from the backlight 30 so as to display images.

The barrier drive section 43 drives the barrier section 10 based on the barrier control signal provided from the controller 41. The barrier section 10 allows light having exited from the backlight 30 and having transmitted through the display section 20 to transmit therethrough (open operation) or blocks the light (close operation), and includes plural open and close sections 11 and 12 (described later) constituted by liquid crystals.

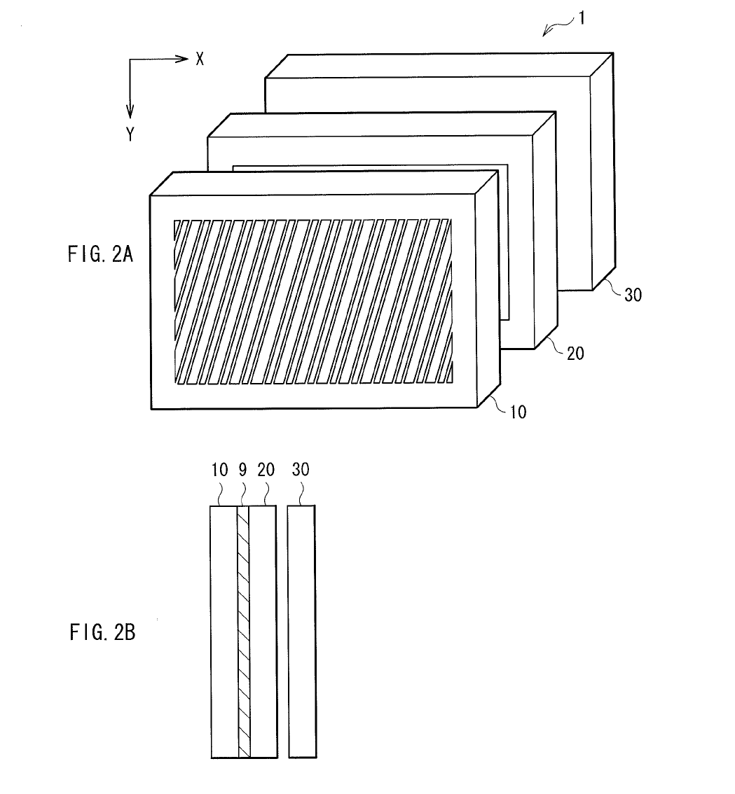

FIGS. 2A and 2B each illustrate one configuration example of a main part of the stereoscopic display device 1, in which FIG. 2A is an exploded perspective view of the stereoscopic display device 1 and FIG. 2B is a side view of the stereoscopic display device 1. As illustrated in FIGS. 2A and 2B, in the stereoscopic display device 1, the respective components are arranged in the order of the backlight 30, the display section 20, and the barrier section 10. Specifically, light having exited from the backlight 30 reaches a viewer via the display section 20 and the barrier section 10.

A spacer 9 is disposed between the display section 20 and the barrier section 10. With this configuration, the stereoscopic display device 1 keeps a constant distance between the display section 20 and the barrier section 10, and suppresses bowing of these components.

### (Display Drive Section 50 and Display Section 20)

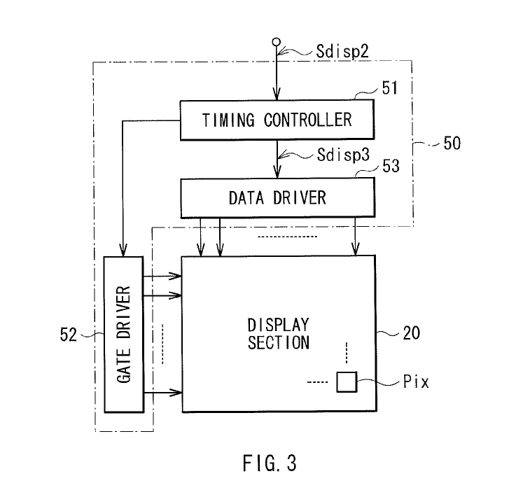

FIG. 3 illustrates one example of a block diagram of the display drive section 50. The display drive section 50 includes a timing controller 51, a gate driver 52, and a data driver 53. The timing controller 51 controls driving timing of the gate driver 52 and the data driver 53, and generates an image signal Sdisp3 based on the image signal Sdisp2 provided from the controller 41, and provides this generated image signal to the data driver 53. The gate driver 52 sequentially selects pixels Pix contained in each line in the display section 20 one line by one line in accordance with the timing control carried out by the timing controller 51, so as to perform line sequential scanning. The data driver 53 provides each pixel Pix in the display section 20 with a pixel signal based on the image signal Sdisp3. Specifically, the data driver 53 performs D/A (digital/analog) conversion based on the image signal Sdisp3 so as to generate an image signal that is an analogue signal, and provides this generated signal for each pixel Pix.

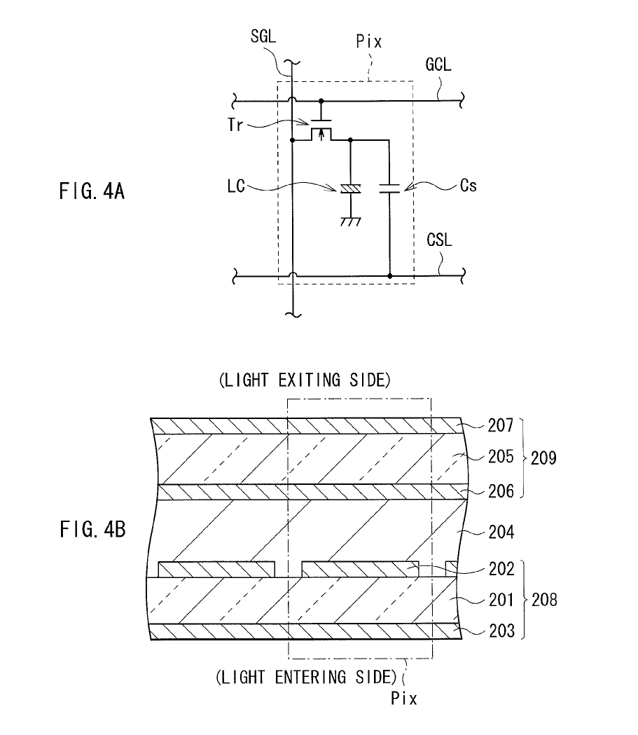

FIGS. 4A and 4B each illustrate one configuration example of the display section 20, in which FIG. 4A illustrates one example of a circuit diagram of each pixel Pix, and FIG. 4B illustrates a cross sectional configuration of the display section 20.

Each pixel Pix includes a TFT (thin-film transistor) element Tr, a liquid crystal element (LC) and a retention capacity element Cs, as illustrated in FIG. 4A. The TFT element Tr is constituted by MOS-FET (metal oxide semiconductor-field effect transistor), for example, in which a gate is connected to a gate line GCL and a source is connected to a data line SGL, and a drain is connected to one end of the liquid crystal element LC and to one end of the retention capacity element Cs. One end of the liquid crystal element LC is connected to a drain of the TFT element Tr and the other end thereof is connected to the earth. One end of the retention capacity element Cs is connected to a drain of the TFT element Tr and the other end thereof is connected to a retention capacity line CSL. The gate line GCL is connected to the gate driver 52 and the data line SGL is connected to the data driver 53.

The display section 20 has a configuration in which a liquid crystal layer 204 is sealed between a drive substrate 208 and a counter substrate 209. In this example, the drive substrate 208 is disposed on the light entering side and the counter substrate 209 is disposed on the light exiting side. The drive substrate 208 includes a transparent substrate 201, a pixel electrode 202, and a polarizing plate 203. The transparent substrate 201 is constituted of glass or the like, for example, on which the TFT element Tr is formed. The pixel electrode 202 is disposed in every pixel Pix on the transparent substrate 201. The polarizing plate 203 is attached to an opposite surface to a surface where the pixel electrode 202 is disposed of the transparent substrate 201. The liquid crystal layer 204 includes liquid crystal molecules, and is driven by the so-called VA (vertical alignment) method or the TN (twisted nematic) method, for example. The counter substrate 209 includes a transparent substrate 205, a counter electrode 206, and a polarizing plate 207. The transparent substrate 205 is constituted by glass or the like, for example. On a surface of the transparent substrate 205 which opposes to the liquid crystal layer 204, a not illustrated color filter or black matrixes are formed, on which the counter electrode 206 is further disposed as a common electrode for each pixel Pix. The polarizing plate 207 is attached to an opposite surface to a surface where the counter electrode 206 is disposed of the transparent substrate 205. The polarizing plate 203 and the polarizing plate 207 are so attached as to be crossed-Nicol to each other. Specifically, the transmission axis of the polarizing plate 203 may be set in the horizontal direction X of the display screen, and the transmission axis of the polarizing plate 207 may be set in the vertical direction Y thereof

### (Barrier Section 10 and Barrier Drive Section 43)

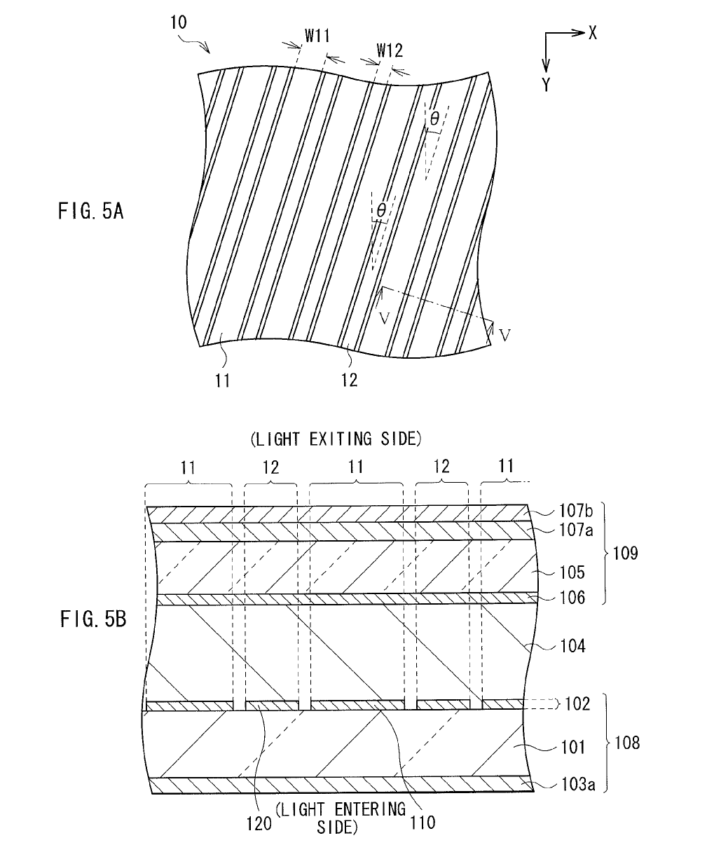

FIGS. 5A and 5B each illustrate one configuration example of the barrier section 10, in which FIG. 5A is a plan view of the barrier section 10, and FIG. 5B illustrates a cross sectional configuration of the barrier section 10 of FIG. 5A as viewed from the direction of the arrow V-V.

The barrier section 10 is a so-called parallax barrier, and includes a plurality of open and close sections (liquid crystal barriers) 11 and 12 for allowing light to transmit therethrough or blocking the light, as illustrated in FIG. 5A. The open and close sections 11 and 12 are disposed to extend in one direction in the X-Y plane (herein, in the direction at a predetermined angle θ relative to the vertical direction Y, for example). In this example, the width W11 of the open and close section 11 is different from the width W12 of the open and close section 12, and their relation may be set to be W11>W12, for example. It should be noted that the multitude correlation of the width between the open and close sections 11 and 12 is not limited to this, and it may be W11<W12 or W11=W12.

The barrier section 10 has a configuration in which a liquid crystal 104 is sealed between a drive substrate 108 and a counter substrate 109, as illustrated in FIG. 5B. In this example, the drive substrate 108 is disposed on the light entering side and the counter substrate 109 is disposed on the light exiting side. The drive substrate 108 includes a transparent substrate 101, a transparent electrode layer 102, and a retardation film 103a. The transparent substrate 101 is constituted of glass or the like, for example, on which the transparent electrode layer 102 is formed. The retardation film 103a is attached to an opposite surface to a surface where the transparent electrode layer 102 is disposed of the transparent substrate 101. The retardation film 103a is used for the purpose of broadening the field of view. The liquid crystal layer 104 includes liquid crystal molecules, and is driven by the so-called VA (vertical alignment) method, the TV (twisted nematic) method, or the like. The counter substrate 109 includes a transparent substrate 105, a transparent electrode layer 106, a retardation film 107a, and a polarizing plate 107b. The transparent substrate 105 is constituted of glass or the like, for example, on which the transparent electrode layer 106 is formed. The retardation film 107a and the polarizing plate 107b are attached in this order to an opposite surface to a surface where the transparent electrode layer 106 is disposed of the transparent substrate 105. The retardation film 107a is used for the purpose of broadening the field of view, as similar to the retardation film 103a.

As illustrated in FIG. 5B, the drive substrate 108 is provided with no polarizing plate, which is different from the counter substrate 109. Specifically, in the stereoscopic display device 1, the polarizing plate 207 disposed on the counter substrate 209 (on the light exiting side) is commonly used as a polarizing plate on the light entering side of the barrier section 10 in the display section 20. By reducing the number of the polarizing plates by one, it is possible to reduce light absorption by the omitted polarizing plate, so as to enhance transmittance of light, thereby reducing chromaticity deviation caused by a polarizing plate, as well as attaining cost reduction. The polarizing plate 107b of the counter substrate 109 is so attached as to be crossed-Nicol relative to the polarizing plate 207.

The transparent electrode layer 102 includes a plurality of transparent electrodes 110 and 120. The transparent electrode layer 106 is disposed across portions corresponding to the plurality of transparent electrodes 110 and 120, serving as a common electrode. The open and close section 11 is constituted by the transparent electrode 110, and portions of the liquid crystal layer 104 and of the transparent electrode layer 106 that are corresponding to the transparent electrode 110. Similarly, the open and close section 12 is constituted by the transparent electrode 120, and portions of the liquid crystal layer 104 and of the transparent electrode layer 106 that are corresponding to the transparent electrode 120. Such a configuration allows the open and close operations to be performed separately on the open and close sections 11 and 12 of the barrier section 10 by selectively applying voltage onto the transparent electrode 110 or the transparent electrode 120, so that the liquid crystal layer 104 has a liquid crystal molecular orientation in accordance with the impressed voltage.

In the barrier section 10, the open and close section 12 is grouped into a plurality of groups (barrier-sub-groups) such that the plurality of open and close sections belonging to the same group perform the open and close operations at the same timing when performing the stereoscopic vision display. The groups of the open and close section 12 will be described as follows.

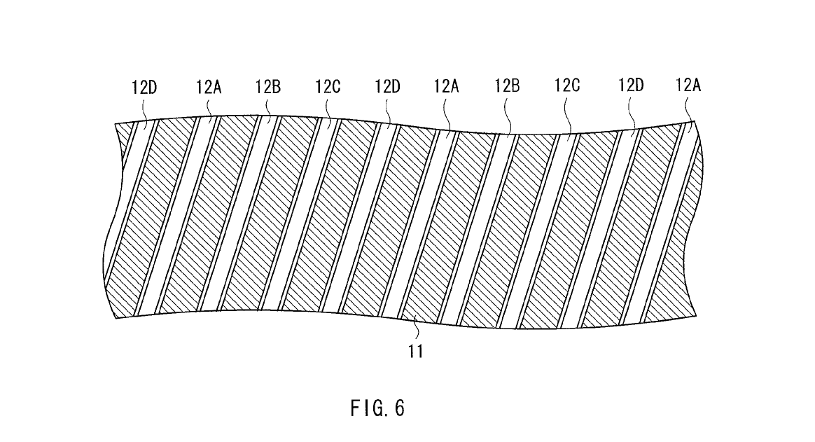

FIG. 6 illustrates an example of a group configuration of the open and close section 12. The open and close section 12 is grouped into four groups: Group A to Group D in this example. Specifically, as illustrated in FIG. 6, the open and close section 12 forming Group A (open and close sections 12A), the open and close section 12 forming Group B (open and close sections 12B), the open and close section 12 forming Group C (open and close sections 12C), and the open and close section 12 forming Group D (open and close sections 12D) are cyclically arranged in this order.

The barrier drive section 43 drives the open and close sections 12 to allow the plurality of open and close sections 12 belonging to the same group to execute the open and close operations at the same timing, in performing the stereoscopic vision display. Specifically, the barrier drive section 43 drives the plurality of open and close sections 12A belonging to Group A to be open or closed together, drives the plurality of open and close sections 12B belonging to Group B to be open or closed together, drives the plurality of open and close sections 12C belonging to Group C to be open or closed together, and drives the plurality of open and close sections 12D belonging to Group D to be open or closed together, so as to execute the open and close operations time-divisionally in a circulating manner from the open and close sections 12A to 12D, as described later.

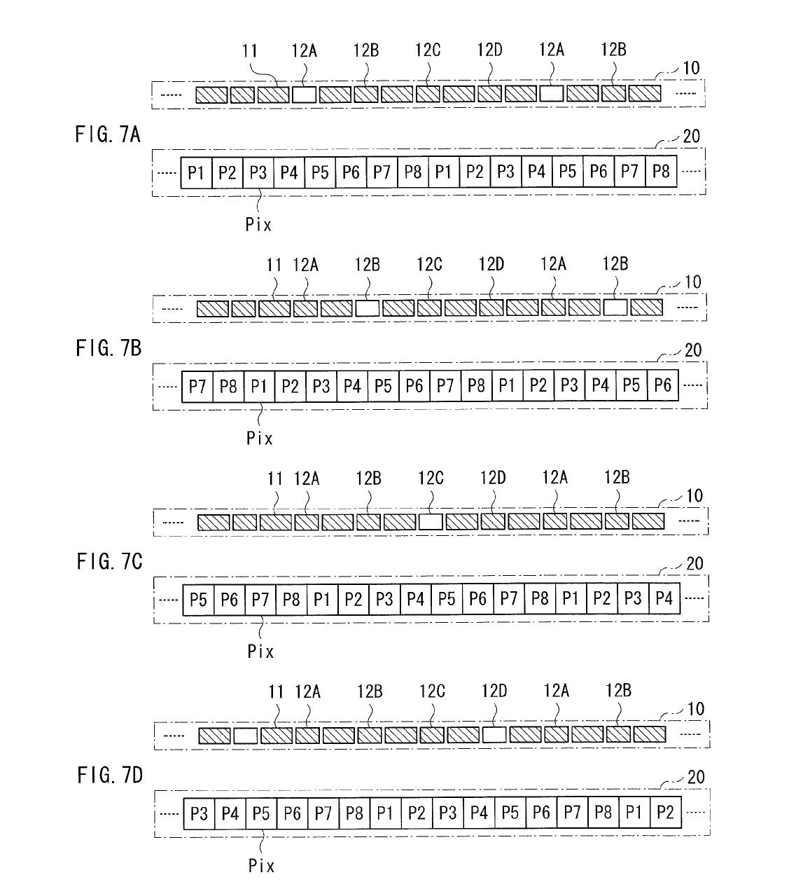

FIGS. 7A to 7D are schematic cross sectional diagrams illustrating one operational example of the barrier section 10 and the display section 20, in which FIGS. 7A to 7D illustrate respective four states in the stereoscopic vision display. In this example, the open and close section 12A is assigned by one every eight pixels Pix of the display section 20. Similarly, as for the open and close sections 12B, 12C and 12D, the open and close section is assigned by one every eight pixels Pix of the display section 20, respectively. In the following description, each pixel Pix is exemplified to include three subpixels (RGB), but the present disclosure is not limited to this, and each pixel Pix may be a subpixel, for example. In FIGS. 7A to 7D, among the open and close sections 11 and 12 (12A to 12D) in the liquid crystal barrier sections 10, the open and close sections that block light are shown shaded.

In the stereoscopic display device 1, the image signal S3D is provided for the display drive section 50 when performing the stereoscopic vision display, and the display section 20 performs the display in accordance with this image signal. In the liquid crystal barrier section 10, the open and close section 11 maintains the closed state (blocking state) and the open and close section 12 (open and close sections 12A to 12D) time-divisionally executes the open and close operations, synchronizing with the display of the display section 20. Specifically, if the barrier drive section 43 drives the open and close section 12A to be in the open state (transmission state), in the display section 20 as illustrated in FIG. 7A, eight pixels Pix adjacent to each other that are located at the positions corresponding to the open and close section 12A display pieces of pixel information P1 to P8 corresponding to eight perspective images. Similarly, if the barrier drive section 43 drives the open and close section 12B to be in the open state (transmission state), in the display section 20 as illustrated in FIG. 7B, eight pixels Pix adjacent to each other that are located at the positions corresponding to the open and close section 12B display pieces of pixel information P1 to P8 corresponding to eight perspective images. If the barrier drive section 43 drives the open and close section 12C to be in the open state (transmission state), in the display section 20 as illustrated in FIG. 7C, eight pixels Pix adjacent to each other that are located at the positions corresponding to the open and close section 12C display pieces of pixel information P1 to P8 corresponding to eight perspective images. If the barrier drive section 43 drives the open and close section 12D to be in the open state (transmission state), in the display section 20 as illustrated in FIG. 7D, eight pixels Pix adjacent to each other that are located at the positions corresponding to the open and close section 12D display pieces of pixel information P1 to P8 corresponding to eight perspective images. Such a configuration allows a viewer to see respective different images with the right and left eyes, so as to perceive the displayed images as a stereoscopic image, as described later. The stereoscopic display device 1 time-divisionally changes over the open and close sections 12A to 12D between the open state and the closed state, so as to display images, thereby enhancing the resolution of the display device, as described later.

When carrying out normal display (2D display), the display section 20 displays a normal 2D image based on the image signal S2D, and the liquid crystal barrier section 10 maintains all the open and close sections 11 and 12 (open and close sections 12A to 12D) to be in the open state (transmission state). Accordingly, a viewer can see a normal 2D image displayed on the display section 20 as it is displayed. (Spacer 9)

The spacer is provided between the display section 20 and the barrier section 10, thereby maintaining a constant distance between the display section 20 and the barrier section 10, as well as suppressing bowing of these components. The spacer will be described as follows.

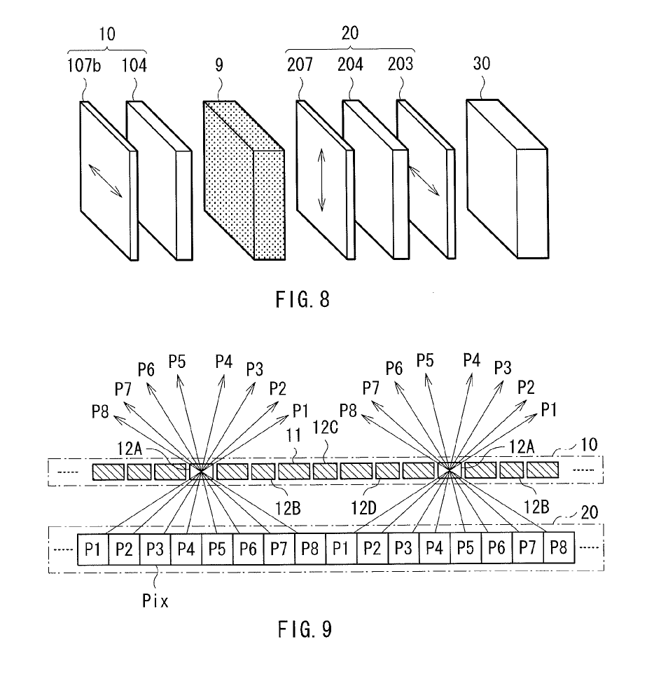

FIG. 8 is a diagram illustrating a schematic configuration of the stereoscopic display device 1. The stereoscopic display device 1 includes the spacer 9. In this example, the spacer 9 is constituted of borosilicate glass, and TEMPAX (Registered Trademark) available from Schott located in Mainz, Germany may be used for the spacer, for example. The thermal expansion coefficient of TEMPAX is approximately 3.3×10⁻⁶ [K⁻¹]. The thermal expansion coefficient may be found in compliance with ISO7991 standard, for example. The spacer 9 serves for maintaining the retardation value R at a predetermined value or less in the operating temperature region of the stereoscopic display device 1. The retardation value R is defined by the following expression.

R=(nx−ny)×d (1)

where nx represents a refractive index in the x direction, ny represents a refractive index in the y direction, and d represents a thickness of the spacer 9. The relation between the refractive index nx and the refractive index ny is expressed by the following expression.

nx≧ny (2)

where the x direction is defined as a slow axis and the y direction is defined as a fast axis. The thermal expansion coefficient of the spacer 9 is small enough to maintain the retardation value R to be small at a predetermined value or less in the operating temperature region, as described above. Specifically, the thermal expansion coefficient of the spacer 9 is small enough to maintain the retardation value R at a predetermined value or less, even when the spacer 9 is expanded as the temperature becomes higher and stress is generated in the space 9 so that the retardation value R becomes increased.

Light having exited from the backlight 30 first enters the display section 20. The light having entered the display section 20 enters the polarizing plate 203 disposed on the light entering side, and is linearly polarized in the direction in accordance with the transmission axis thereof, and then enters the liquid crystal layer 204. In the liquid crystal layer 204, the orientation of the liquid crystal molecules in the liquid crystal element LC is changed depending on the pixel signal, so that the polarization direction of the light having entered the liquid crystal layer 204 is changed. The light having transmitted through the liquid crystal layer 204 enters the polarizing plate 207 disposed on the light exiting side, and then only the light having the polarization direction in accordance with the transmission axis of the polarizing plate 207 transmits through this polarizing plate 207.

The light having transmitted through the display section 20 enters the spacer 9. The polarization direction of the light is mostly retained in the spacer 9. The light having transmitted through the spacer 9 enters the barrier section 10. The light having entered the barrier section 10 then enters the liquid crystal layer 104. In the liquid crystal layer 104, the polarization direction of the light is changed in accordance with the orientation of the liquid crystal molecules in the open and close sections 11 and 12. The light having transmitted through the liquid crystal layer 104 enters the polarizing plate 107b disposed on the light exiting side, and then only the light having the polarization direction in accordance with the transmission axis of the polarizing plate 107a transmits through this polarizing plate 107b.

The display section 20 corresponds to one specific but not limitative example of the “liquid crystal display section” in one embodiment of the present disclosure. The open and close section 12 corresponds to one specific but not limitative example of the “first group of liquid crystal barriers” in one embodiment of the present disclosure, and the open and close section 11 corresponds to one specific but not limitative example of the “second group of liquid crystal barriers” in one embodiment of the present disclosure.

### [Operation and Effects]

Description will be provided on the operation and effects of the stereoscopic display device of the present embodiment, as follows.

### (Outline of Overall Operation)

With reference to FIG. 1 and others, the outline of the overall operation of the stereoscopic display device 1 will now be described. The controller 41 controls the backlight drive section 42, the display drive section 50, and the barrier drive section 43 based on the image signal Sdisp provided from the outside. The backlight drive section 42 drives the backlight 30 based on the backlight control signal provided from the controller 41. The backlight 30 radiates surface-emitted light relative to the display section 20. The display drive section 50 drives the display section 20 based on the image signal Sdisp2 provided from the controller 41. The display section 20 modulates the light that has exited from the backlight 30 so as to display the image. The barrier drive 43 controls the barrier section 10 based on the barrier control signal provided from the controller 41. The open and close sections 11 and 12 of the barrier section 10 execute the open and close operations based on the instructions from the barrier drive section 43, and allow light, having exited from the backlight 30 and having transmitted through the display section 20, to transmit therethrough or block the light.

Detailed operation to perform the stereoscopic vision display will be described as follows.

FIG. 9 illustrates an operational example of the display section 20 and the liquid crystal barrier section 10 when the barrier drive section 43 drives the open and close section 12A to be in the open state (transmission state). In this case, the open and close section 12A is set in the open state (transmission state), the open and close sections 12B to 12D are set in the closed state (blocking state), and the display section 20 displays the pieces of pixel information P1 to P8 corresponding to the respective eight perspective images included in the image signal S3D in the respective pixels Pix located in the vicinity of the open and close section 12A. Through this operation, light having exited from each pixel Pix of the display section 20 is restricted in its angle by the open and close section 12A, and resultant light is output therefrom. The viewer, for example, sees the pixel information P4 with the left eye and sees the pixel information P5 with the right eye, which enables the viewer to see a stereoscopic image. In this example, description has been provided on the case in which the barrier drive section 43 drives the open and close section 12A to be in the open state, and the same is true for the respective cases where the open and close sections 12B to 12D are driven to be in the open state.

The viewer sees respective different pieces of pixel information among the pieces of pixel information P1 to P8 with the left and right eyes, so that the viewer perceives the different pieces of pixel information as the stereoscopic image. Images are displayed by time-divisionally executing the open and close operations on the open and close sections 12A to 12D in order, so that the viewer sees the images at shifted positions from each other in an averaged fashion. Therefore, the stereoscopic display device 1 realizes the resolution four times as many as the case of using only the open and close section 12A. Specifically, the resolution of the stereoscopic display device 1 is only ½(=⅛×4) as compared with the 2D display.

### (Operation of Spacer 9)

As aforementioned, the spacer 9 is so disposed as to keep a constant distance between the display section 20 and the barrier section 10, and to suppress the bowing of these components. The spacer 9 also has a function of, while retaining the polarization direction of light having entered from the display section 20 substantially as it is, transmitting this light to the display section 20. Specifically, the spacer 9 keeps the retardation value R to be small at the predetermined value or less, thereby maintaining the polarization direction of the light substantially as it is, even when the ambient temperature of the stereoscopic display device 1 is changed. Detailed description thereof will be provided as follow.

When the spacer 9 expands or shrinks in accordance with the temperature, a stress is generated in various directions in a plane thereof.

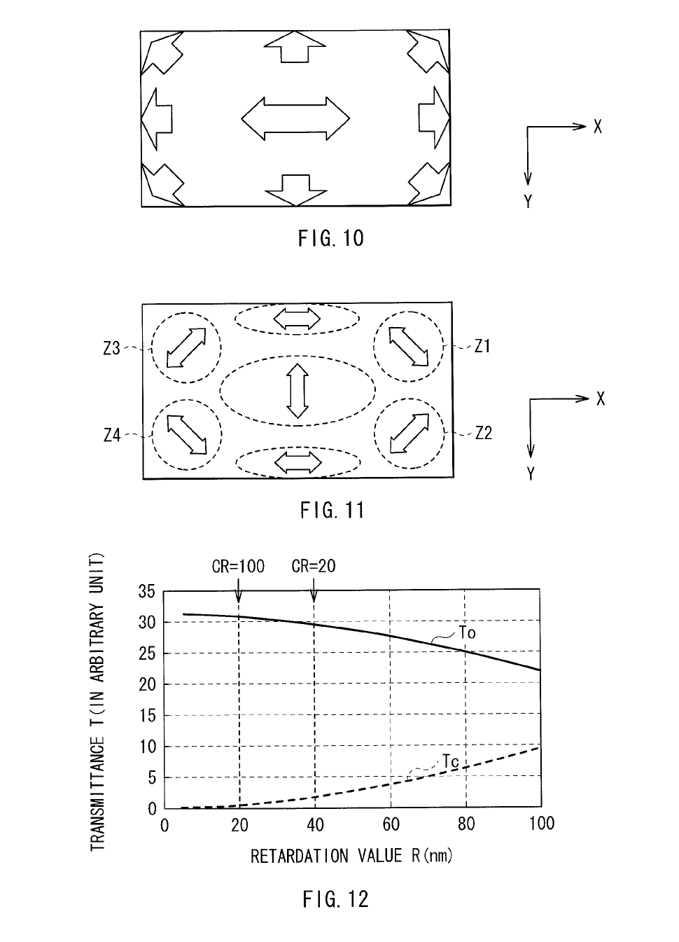

FIG. 10 illustrates one example of the directions of stress due to thermal expansion in the plane of the spacer 9. In this example, the stress works in the horizontal direction X in the longitudinal direction of the spacer 9 in the vicinity of the center in the plane of the spacer 9, and the stress works outward at the periphery in the plane of the spacer 9, for example as illustrated in FIG. 10.

As known as the Brewster's law, such a stress distribution in the plane of the spacer 9 causes a change in phase of light in accordance with the polarization direction of the light having entered the spacer 9, resulting in retardation (retardation value R).

FIG. 11 shows the distribution of the direction of the slow axis in the plane of the spacer 9 at a high temperature. In this example, the slow axis is generated in the vertical direction to the stress direction of FIG. 10. Specifically, the direction of the slow axis is orientated in the vertical direction Y in the vicinity of the center in the plane of the spacer 9, and orientated in the diagonal direction in portions Z1 to Z4 that are in the vicinity of the corners. Accordingly, the spacer 9 delays the phase of light polarized in the direction of the slow axis, and progresses the phase of light polarized in the vertical direction of the slow axis (fast axis direction), so that the polarization direction of the light having entered the spacer 9 may be changed in some cases, as described later as a comparative example. However, even when there is a generation of such retardation in the plane of the spacer 9, the retardation value R is set to be small as described later, thereby suppressing a change in the polarization direction in the spacer 9.

The light having transmitted through the spacer 9 transmits through the liquid crystal layer 104, and then enters the polarizing plate 107b in the barrier section 10. At this time, when the open and close sections 11 and 12 of the barrier section 10 are in the open state, the polarization direction is changed by approximately 90 degrees in the liquid crystal layer 104 and most of the light having entered the barrier section 10 transmits through the polarizing plate 107b. When the open and close sections 11 and 12 of the barrier section 10 are in the closed state, the polarization direction hardly changes in the liquid crystal layer 104, and most of the light having entered the barrier section 10 is blocked by the polarizing plate 107b.

FIG. 12 shows simulation results of the relation between the retardation value R in the spacer 9 and the transmittance T in the barrier section 10 for the light having entered from the display section 20 through the spacer 9. FIG. 12 represents the simulation, at the portions Z1 to Z4 of FIG. 11, of the transmittance To for the open and close sections 11 and 12 of the barrier section 10 in the open state, and of the transmittance Tc for the open and close sections 11 and 12 of the barrier section 10 in the closed state.

As shown in FIG. 12, in the barrier section 10, the transmittance To in the open state becomes higher and the transmittance Tc in the closed state becomes smaller toward zero, as the retardation value R of the spacer 9 is smaller. Specifically, as the retardation value R is smaller, the polarization direction of light in the spacer 9 is less likely to be changed, so that the barrier section 10 sufficiently transmits light in the open state and sufficiently blocks the light in the closed state. In other words, the smaller the retardation value R in the spacer 9 is, the greater the contrast CR becomes (corresponding to the transmittance ratio between the open state and the closed state: To/Tc).

Since the thermal expansion coefficient is relatively small in the spacer 9, the stress caused by the thermal expansion can be made small even when the temperature is changed, thereby suppressing the retardation value R to be smaller. Specifically, a material having a smaller thermal expansion coefficient is used for the spacer 9 so as to suppress the retardation value R at a lower level in the operating temperature region. Thus, since the change in the polarization direction in the spacer 9 can be made small, it is possible to enhance the transmittance To in the open state, and to reduce the transmittance Tc in the closed state.

### (Retardation Value R in Spacer 9)

Description will now be provided on the preferred retardation value R in the spacer 9. In the following example, crosstalk characteristics in the stereoscopic vision display is used so as to find a preferred contrast value CR first, and then find a preferred retardation value R based on the found contrast value CR using FIG. 12. Detailed description thereof will be provided as follows.

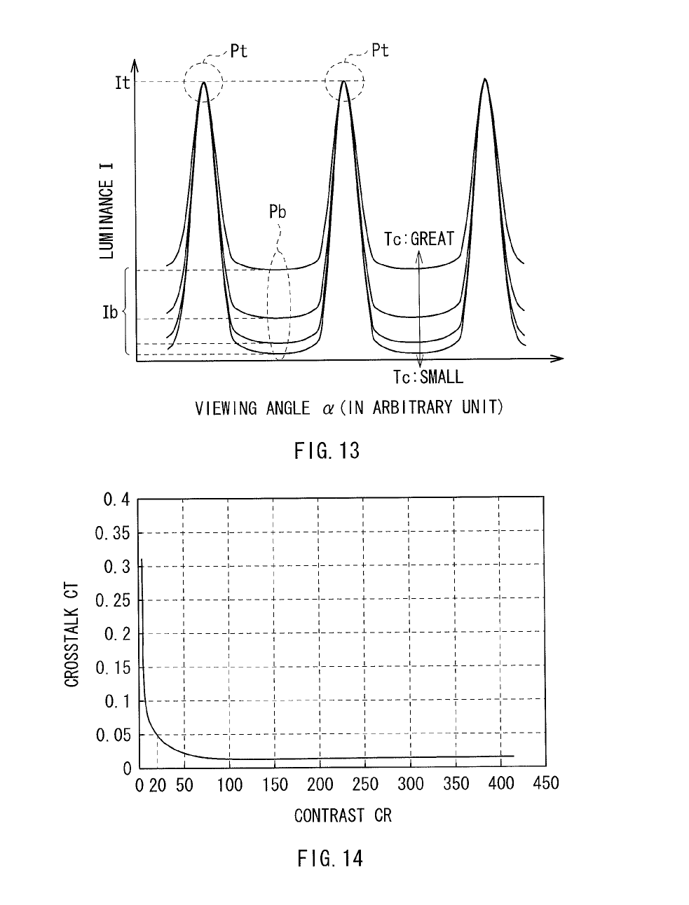

FIG. 13 shows the crosstalk characteristics of the stereoscopic display device 1. FIG. 13 is a characteristic diagram for evaluating a so-called crosstalk in which perspective images different from one another are mixed in stereoscopic vision display. The crosstalk illustrated in FIG. 13 is obtained as follows. First, the display section 20 displays eight perspective images in which certain perspective images are white (white images) entirely and the remaining perspective images are black (black images) entirely. Then, the barrier section 10 sets only the open and close section 12 belonging to a certain group (the open and close sections 12A belonging to the group A, for example) to be in the open state (transmission state) all the time, and sets the open and close section 12 belonging to other groups to be in the closed state (blocking state) all the time. Then, the luminance I at every viewing angle α is measured while changing the viewing angle α, thereby obtaining the crosstalk characteristics as shown in FIG. 13. In this example, in the barrier section 10, several transmittances Tc are set by applying different drive voltages to the open and close sections 11 and 12 in the closed state (blocking state), and the crosstalk characteristics are measured for each of these transmittances Tc.

As shown in FIG. 13, the luminance I becomes greater at the viewing angle α where a viewer sees, through the open and close sections 12 in the open state, pieces of pixel information regarding the perspective images of white images (portions Pt), and the luminance I becomes smaller at the viewing angle α where the viewer sees, through the open and close sections 12 in the open state, pieces of pixel information regarding the perspective images of black images (portions Pb). One reason why the luminance I becomes greater in the portions Pb as the transmittance Tc in the closed state (blocking state) becomes greater is that a part of the light of the pieces of pixel information regarding the perspective images of the white images is more likely to transmit through the open and close sections 11 and 12 in the closed state as the transmittance Tc becomes greater.

The crosstalk CT is defined as follows.

CT=Ib/It

where It represents a maximum value of the luminance I, and Ib is a minimum value of the luminance I. In other words, the crosstalk CT is preferably as small as possible.

Meanwhile, in the same manner as the case of obtaining the above-described crosstalk characteristics, it is possible to find the contrast CR in the stereoscopic display device 1 by applying different drive voltages (so-called black voltage) to the open and close sections 11 and 12 so as to set several transmittances Tc. Therefore, a pair of data of the crosstalk CT and the contrast CR in every black voltage is obtained for various black voltages, so as to obtain the relation between the crosstalk CT and the contrast CR.

FIG. 14 shows the relation between the contrast CR and the crosstalk CT. As shown in FIG. 14, if the contrast CR is 100 or more, the crosstalk CT is substantially constant, which shows the crosstalk CR has a sufficiently low value. If the contrast CR becomes 100 or less, the crosstalk CT starts to increase. In this graph, the contrast CR of 100 or more hardly causes deterioration of image quality due to the crosstalk, and if the contrast CR is 100 or less but 20 or more, the crosstalk CT is approximately 5% or less, which means it is unlikely that the image quality deteriorates significantly by the crosstalk.

As shown in FIG. 12, the contrast CR=100 corresponds to the retardation value R=20 [nm]. Specifically, if the retardation value R is 20 [nm] or less, the contrast CR is 100 or more, so that there is hardly any deterioration of image quality due to the crosstalk, as illustrated in FIG. 14. On the other hand, the contrast CR=20 corresponds to the retardation value R=40 [nm], as illustrated in FIG. 12. Specifically, if the retardation value R is 40 [nm] or less, the contrast CR is 20 or more, which means it is unlikely that the image quality deteriorates significantly by the crosstalk.

Accordingly, the retardation value R of the spacer 9 is preferably 40 [nm] or less, and more preferably 20 [nm] or less.

In order to suppress the retardation value R to be small in such a manner, possible alternatives may include reduction of the thickness of the spacer 9, as suggested by the Brewster's law. Unfortunately, the spacer 9 is provided for guiding light, having exited from the pixels Pix of the display section 20, in the respective directions thereof, as illustrated in FIG. 9, and the thickness “d” of the spacer 9 is defined depending on the size and the resolution of the screen. Therefore, it is not easy to reduce the thickness of the spacer 9.

In the stereoscopic display device 1, a material having a smaller thermal expansion is used for the spacer 9, so that it is possible to suppress a stress resulting from thermal expansion to be smaller, and to suppress the retardation value to be smaller without reducing the thickness of the spacer 9.

### COMPARATIVE EXAMPLE

Description will be provided on a comparative example as follows. A stereoscopic display device 1R according to the comparative example includes a spacer 9R. The spacer 9R is so-called blue-sheet glass made of soda-lime glass. The thermal expansion coefficient of the spacer 9R is approximately 9.0×10⁻⁶[K⁻¹]. Specifically, this is approximately three times as great as the thermal expansion coefficient of the spacer 9 according to the above-described embodiment (approximately 3.3×10⁻⁶[K⁻¹]).

In the case of using the spacer 9R, a higher temperature causes thermal expansion and generates stress distribution due to the thermal expansion as illustrated in FIG. 10, for example, thereby causing distribution in the direction of the slow axis as illustrated in FIG. 11, for example. The spacer 9R according to the comparative example has a greater thermal expansion coefficient than that of the spacer 9 according to the present embodiment, so that the retardation of light (retardation value R) becomes great. Therefore, the polarization direction of light that transmits through the spacer 9R changes significantly.

Specifically, as illustrated in FIG. 11, the polarization direction is significantly changed in the portions Z1 to Z4 that are in the vicinity of the corners in a plane of the spacer 9R. Specifically, in this example as illustrated in FIG. 8, since the transmission axis of the polarizing plate 207 is set in the vertical direction Y, the light entering the spacer 9R is linearly polarized in the vertical direction Y. Hence, the linearly polarized light having entered the spacer 9R becomes circular polarized light, particularly in the portions Z1 to Z4, where the phase of the component in the slow axis direction is delayed and the phase of the component in the fast axis direction is progressed.

The light having transmitted through the spacer 9R transmits through the liquid crystal layer 104, and then the light enters the polarizing plate 107b of the barrier section 10. At this time, the polarization direction of the light is changed by not only the liquid crystal layer 104 but also the spacer 9R, for example. Consequently, particularly in portions corresponding to the portions Z1 to Z4 in the display screen of the stereoscopic display device 1R, a part of the light is blocked so that the display screen becomes dark even if the open and close sections 11 and 12 are in the open state, and light slightly leaks even if the open and close sections 11 and 12 are in the closed state. In particular, when the open and close sections 11 and 12 are in the closed state, a slight difference in transmittance may be sensed as luminance unevenness.

In this example, the retardation value R in the spacer 9R according to the comparative example is estimated to be approximately 56 [nm] based on the measurement of the contrast CR. Specifically, this value is approximately three times as great as the preferred value of the retardation value R (20 [nm]) in the spacer 9 according to the above embodiment. Therefore, in the barrier section 10 as shown in FIG. 12, the transmittance To in the open state becomes smaller, and the transmittance Tc in the closed state becomes greater.

As described above, in the stereoscopic display device 1R according to the comparative example, the thermal expansion coefficient of the spacer 9R becomes relatively great, so that the stress due to the thermal expansion caused by the change in temperature is increased, resulting in increase of the retardation value R, which may consequently cause insufficient blocking or transmission of light.

In contrast, in the stereoscopic display device 1 according to the present embodiment, a thermal expansion coefficient in the spacer 9 is made small. Hence, the stress generated due to thermal expansion is kept small even when the temperature is changed and the retardation value R is thus kept small, making it possible for the barrier section 10 to block or transmit the light sufficiently.

### ADVANTAGEOUS EFFECTS

As described above, in the present embodiment, the retardation value R is set preferably to be 40 [nm] or less, and is set desirably to be 20 [nm] or less, so that it is possible to enhance the transmittance To in the open state and to reduce the transmittance in the closed state, thereby suppressing the deterioration of the image quality.

Also, in the present embodiment, the spacer is configured by a material having a smaller thermal expansion coefficient, so that even when the temperature is changed, it is possible to keep the stress generated due to the thermal expansion to be small, and to keep the retardation value to be small, thereby suppressing the deterioration of the image quality.

### [Modification 1]

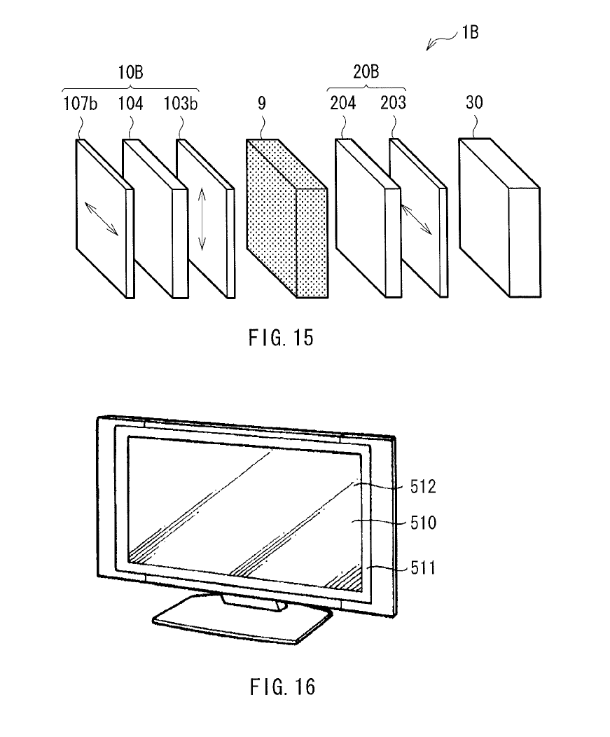

The above-described embodiment, as illustrated in FIGS. 5A, 5B, and 8, eliminates the polarizing plate of the drive substrate 108 (light entering side) in the barrier section 10, and commonly uses the polarizing plate 207 disposed for the counter substrate 209 (light exiting side) in the display section 20 as the polarizing plate on the light entering side of the barrier section 10, but the present disclosure is not limited to this. Alternatively, as illustrated in FIG. 15 for example, the polarizing plate of the counter substrate 209 (light exiting side) in the display section 20B may be omitted and the polarizing plate 103b may be disposed for the counter substrate 108 (light entering side) in the display section 20B, so as to commonly use this polarizing plate 103b as the polarizing plate on the exiting side of the display section 20B.

### [Modification 2]

In the above-described embodiment, borosilicate glass is used for the spacer 9, but the present disclosure is not limited to this, and any other glass or plastic material may be used as far as the material has a retardation value of 40 [nm] or less.

### 2. APPLICATION EXAMPLES

Description will now be provided on application examples of the stereoscopic display device described in the present embodiment and the modifications.

FIG. 16 illustrates an appearance of a television apparatus to which the stereoscopic display device according to any of the above-described embodiment and the modifications is applied. The television apparatus is provided with an image display screen section 510 including a front panel 511 and a filter glass 512. This image display screen section 510 is constituted by the stereoscopic display device according to any of the above-described embodiment and the modifications.

The stereoscopic display device according to any of the above-described embodiment and the modifications is applicable to various electronic apparatuses of any field, such as, but not limited to, a digital camera, a notebook-sized personal computer, a mobile terminal including a mobile phone and the like, a portable game machine, and a video camera, other than the above-described television apparatus. In other words, the stereoscopic display device according to any of the above-described embodiment and the modifications is applicable to any electronic apparatus for displaying images of every field.

As aforementioned, descriptions have been made on the embodiment and the modifications as well as the application examples applied to electronic apparatus, but the present technology is not limited to these embodiment, the modifications, and the application examples, and various modifications can be made.

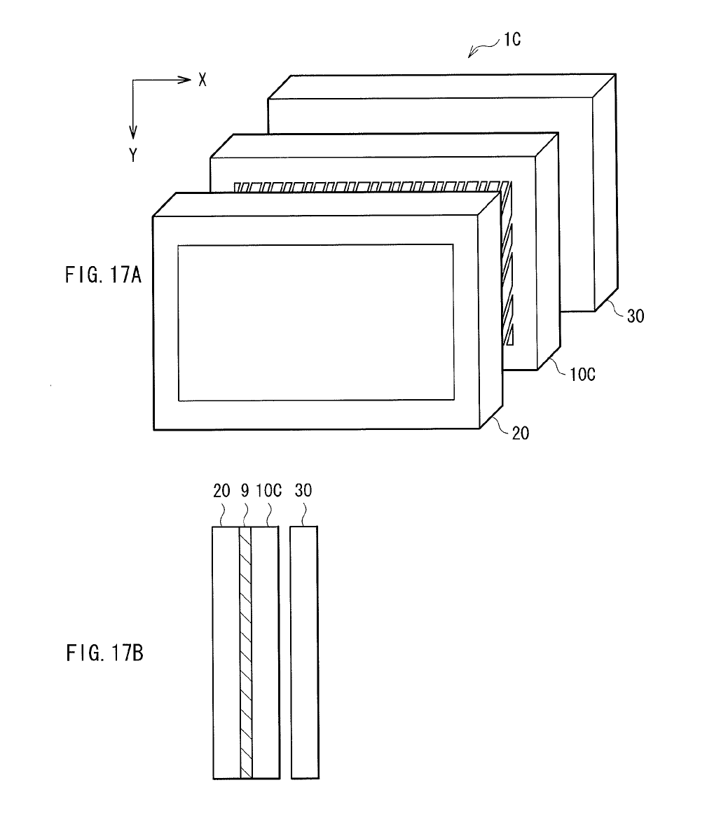

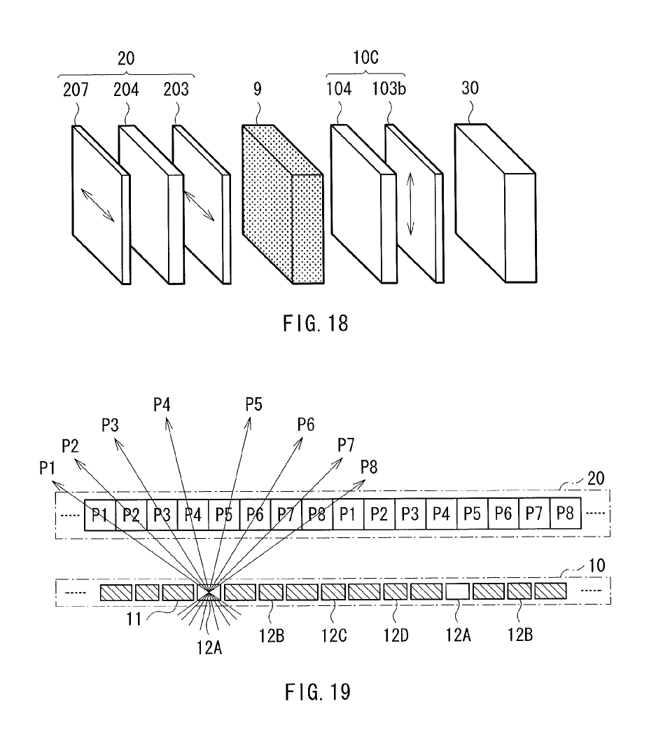

For example, in the above-described embodiment, the modifications, and the application examples, the respective components are arranged in the order of the backlight 30, the display section 20, and the barrier section 10, but the present disclosure is not limited to this order, and they may be arranged in the order of the backlight 30, a barrier section 10C, and the display section 20 instead, as illustrated in FIGS. 17A and 17B. In this case, for example as illustrated in FIG. 18, the polarizing plate 103b may be disposed for the drive substrate 108 (light entering side) of the barrier section 10C and the polarizing plate of the counter substrate 109 (light exiting side) may be omitted, so as to commonly use the polarizing plate 203 of the drive substrate 208 (light entering side) of the display section 20 as the polarizing plate on the exiting side of the barrier section 10C. FIG. 19 illustrates an operational example of the display section 20 and the liquid crystal barrier section 10 when the open and close section 12A is in the open state (transmission state) in a stereoscopic display device 1C according to the present modification. In the present modification, light that has exited from the backlight 30 first enters the barrier section 10. Of this incident light, only light having transmitted through the open and close sections 12A to 12D is modulated in the display section 20, and eight perspective images are output.

For example, in the above-described embodiment, the modifications, and the application examples, the open and close sections 12 constitute the four Groups A to D, but the present disclosure is not limited to this, and the open and close sections 12 may constitute three or less groups, or five or more groups instead.

In the above-described embodiment, the modifications, and the application examples, the open and close sections 12 are each configured to be time-divisionally changed over between the open state and the closed state in the stereoscopic vision display, but the present disclosure is not limited to this, and the open and close section 12 may be kept in the open state throughout the stereoscopic vision display operation.

In the above-described embodiment, the modifications, and the application examples, the display section 20 displays eight perspective images, but the present disclosure is not limited to this, and the display section 20 may display seven or less perspective images, or nine or more perspective images instead.

In the above-described embodiment, the modifications, and the application examples, the open and close sections 11 and 12 are disposed to extend obliquely at a predetermined angle relative to the vertical direction Y, but the present disclosure is not limited to this. The open and close sections 11 and 12 may be formed stepwise (step barrier system) or formed to extend in the vertical direction Y instead, for example. The step barrier system is described in Japanese Unexamined Patent Application Publication No. 2004-264762, for example.

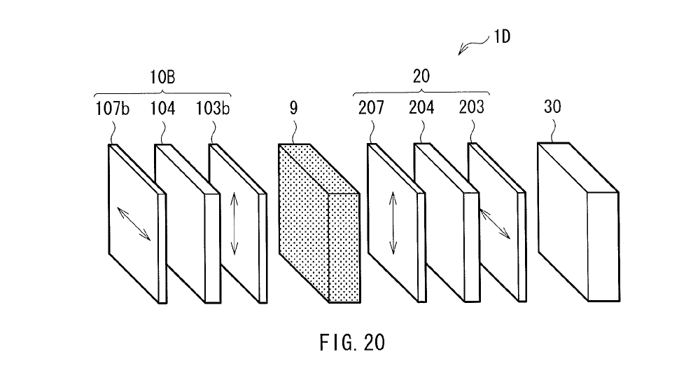

In the above-described embodiment, the modifications, and the application examples, the polarizing plate of the drive substrate 108 (light entering side) of the barrier section 10 is omitted, but the present disclosure is not limited to this, and the polarizing plate may not be omitted instead, as illustrated in FIG. 20, for example. In this case, the polarization direction of light having entered the spacer 9 is changed in the space 9, which may cause variation in luminance. If distribution in the direction of the slow axis is generated as illustrated in FIG. 11, luminance unevenness occurs in a plane of the display screen. Even in such a case, however, it is possible to reduce luminance unevenness and to suppress deterioration of the image quality, by maintaining the retardation value R to be small at a predetermined value or less.

Accordingly, it is possible to achieve at least the following configurations from the above-described example embodiments, the modifications, and the application examples of the disclosure.

(1) A display device, including:

a liquid crystal display section displaying an image;

a barrier section including liquid crystal barriers allowed to switch between open state and closed state; and

a spacer disposed between the liquid crystal display section and the barrier section, and having a retardation value of 40 [nm] or less.

(2) The display device according to (1), wherein the retardation value is 20 [nm] or less.
(3) The display device according to (1) or (2), wherein the spacer is configured of a glass material.
(4) The display device according to (3), wherein the glass material is borosilicate glass.
(5) The display device according to (1) or (2), wherein the spacer is configured of a plastic material.
(6) The display device according to any one of (1) to (5), wherein the spacer has a thermal expansion coefficient of 3.3×10⁻⁶ [K⁻¹] or less.
(7) The display device according to any one of (1) to (6), wherein

the liquid crystal display section includes a display liquid crystal layer, and a first polarizing plate and a second polarizing plate between which the liquid crystal layer is disposed, and

the barrier section includes a barrier liquid crystal layer, and a third polarizing plate disposed on an opposite side of the barrier liquid crystal layer from the spacer.

(8) The display device according to any one of (1) to (6), wherein

the liquid crystal display section includes a display liquid crystal layer, and a first polarizing plate disposed on an opposite side of the display liquid crystal layer from the spacer, and

the barrier section includes a barrier liquid crystal layer, and a second polarizing plate and a third polarizing plate between which the barrier liquid crystal layer is disposed.

(9) The display device according to any one of (1) to (6), wherein

the liquid crystal display section includes a display liquid crystal layer, and a first polarizing plate and a second polarizing plate between which the display liquid crystal layer is disposed, and

the barrier section includes a barrier liquid crystal layer, and a third polarizing plate and a fourth polarizing plate between which the barrier liquid crystal layer is disposed.

(10) The display device according to any one of (1) to (9), wherein the barrier section includes a first group of liquid crystal barriers, and a second group of liquid crystal barriers.
(11) The display device according to (10), having a plurality of display modes including a first display mode and a second display mode, wherein

the first display mode allows the liquid crystal display section to display a plurality of perspective images, and allows the barrier section to control light beams from the perspective images or toward the perspective images to travel in respective directions through allowing the first group of liquid crystal barriers to stay in transmission state and allowing the second group of liquid crystal barriers to stay in blocking state,

the second display mode allows the liquid crystal display section to display a single perspective image, and allows the barrier section to control light beams from the single perspective image or toward the single perspective image to pass through without any change of direction through allowing the first and second groups of liquid crystal barriers to stay in transmission state.

(12) The display device according to (11), wherein

the first group of liquid crystal barriers are grouped into a plurality of barrier sub-groups, and

the first display mode allows each of the barrier sub-groups of the first group of liquid crystal barriers to time-divisionally switch between open state and closed state.

(13) The display device according to any one of (1) to (12), further including a backlight, wherein the liquid crystal display section is disposed between the backlight and the barrier section.
(14) The display device according to any one of (1) to (12), further including a backlight, wherein the barrier section is disposed between the backlight and the liquid crystal display section.
(15) A spacer disposed between two polarizing plates, the spacer having a retardation value of 40 [nm] or less.
(16) An electronic apparatus having a display device, and a controller performing operation control using the display device, the display device including:

a liquid crystal display section displaying an image;

a barrier section including liquid crystal barriers allowed to switch between open state and closed state; and

a spacer disposed between the liquid crystal display section and the barrier section, and having a retardation value of 40 [nm] or less.

It is to be noted that any combinations of (2) to (14) directed to the display device are applicable to each of (15) directed to the spacer and (16) directed to the electronic apparatus unless any contradictions occur. Such combinations are also considered as preferred combinations of embodiments according to the technology.

The present disclosure contains subject matter related to that disclosed in Japanese Priority Patent Application JP 2011-232101 filed in the Japan Patent Office on Oct. 21, 2011, the entire content of which is hereby incorporated by reference.

It should be understood by those skilled in the art that various modifications, combinations, sub-combinations and alternations may occur depending on design requirements and other factors insofar as they are within the scope of the appended claims or the equivalents thereof.

What is claimed is:

1. A display device, comprising:
a liquid crystal display section displaying an image;
a barrier section including liquid crystal barriers allowed to switch between open state and closed state; and
a spacer disposed between the liquid crystal display section and the barrier section, and having a retardation value of 40 [nm] or less.

2. The display device according to claim 1, wherein the retardation value is 20 [nm] or less.

3. The display device according to claim 1, wherein the spacer is configured of a glass material.

4. The display device according to claim 3, wherein the glass material is borosilicate glass.

5. The display device according to claim 1, wherein the spacer is configured of a plastic material.

6. The display device according to claim 1, wherein the spacer has a thermal expansion coefficient of 3.3×10⁻⁶ [K⁻¹] or less.

7. The display device according to claim 1, wherein
the liquid crystal display section includes a display liquid crystal layer, and a first polarizing plate and a second polarizing plate between which the liquid crystal layer is disposed, and
the barrier section includes a barrier liquid crystal layer, and a third polarizing plate disposed on an opposite side of the barrier liquid crystal layer from the spacer.

8. The display device according to claim 1, wherein
the liquid crystal display section includes a display liquid crystal layer, and a first polarizing plate disposed on an opposite side of the display liquid crystal layer from the spacer, and
the barrier section includes a barrier liquid crystal layer, and a second polarizing plate and a third polarizing plate between which the barrier liquid crystal layer is disposed.

9. The display device according to claim 1, wherein
the liquid crystal display section includes a display liquid crystal layer, and a first polarizing plate and a second polarizing plate between which the display liquid crystal layer is disposed, and
the barrier section includes a barrier liquid crystal layer, and a third polarizing plate and a fourth polarizing plate between which the barrier liquid crystal layer is disposed.

10. The display device according to claim 1, wherein the barrier section includes a first group of liquid crystal barriers, and a second group of liquid crystal barriers.

11. The display device according to claim 10, having a plurality of display modes including a first display mode and a second display mode, wherein
the first display mode allows the liquid crystal display section to display a plurality of perspective images, and allows the barrier section to control light beams from the perspective images or toward the perspective images to travel in respective directions through allowing the first group of liquid crystal barriers to stay in transmission state and allowing the second group of liquid crystal barriers to stay in blocking state,
the second display mode allows the liquid crystal display section to display a single perspective image, and allows the barrier section to control light beams from the single perspective image or toward the single perspective image to pass through without any change of direction through allowing the first and second groups of liquid crystal barriers to stay in transmission state.

12. The display device according to claim 11, wherein
the first group of liquid crystal barriers are grouped into a plurality of barrier sub-groups, and
the first display mode allows each of the barrier sub-groups of the first group of liquid crystal barriers to time-divisionally switch between open state and closed state.

13. The display device according to claim 1, further comprising a backlight, wherein the liquid crystal display section is disposed between the backlight and the barrier section.

14. The display device according to claim 1, further comprising a backlight, wherein the barrier section is disposed between the backlight and the liquid crystal display section.

15. A spacer disposed between two polarizing plates, the spacer having a retardation value of 40 [nm] or less.

16. An electronic apparatus having a display device, and a controller performing operation control using the display device, the display device comprising:
a liquid crystal display section displaying an image;
a barrier section including liquid crystal barriers allowed to switch between open state and closed state; and
a spacer disposed between the liquid crystal display section and the barrier section, and having a retardation value of 40 [nm] or less.
